(19) United States
(12) Patent Application Publication
(10) Pub. No.: US 2009/0134985 A1
(43) Pub. Date: May 28, 2009

(54) MODULAR SENSOR UNIT FOR A MOTOR VEHICLE

(75) Inventors: Hans-Michael SCHMITT, Munnerstadt (DE); Wolfgang Kuchler, Ostheim (DE); Martin Jeitner, Ostheim (DE); Harald Schelbert, Bad Konigshofen (DE)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Preh GmbH, Bad Neustadt a. d. Saale (DE)

(21) Appl. No.: 12/361,077

(22) Filed: Jan. 28, 2009

(30) Foreign Application Priority Data
Jul. 29, 2006 (DE) DE 102006035184.3
Jul. 25, 2007 (EP) PCT/EP2007/006599

(51) Int. Cl. B60Q 1/00

(52) U.S. Cl. 340/425.5

(57) ABSTRACT

Sensor unit (1) for a motor vehicle for detecting ambient conditions, comprising at least two sensor modules, wherein a first sensor module (2) has a rain (6) and/or condensation sensor (7), and a second sensor module (3) has at least a light (13, 14) and/or solar sensor (11, 12).

### CROSS-REFERENCE TO PRIORITY APPLICATIONS

This application is a continuation of and claims the benefit of the commonly assigned German Patent Application Serial No. 10 2006 035 184.3 (filed Jul. 29, 2006, in the German Patent Office), and the commonly assigned International Patent Application No. PCT/EP2007/006599 (filed Jul. 25, 2007, in the European Patent Office), both of which are hereby incorporated by reference in their entirety.

### FIELD OF THE INVENTION

The present invention relates to a sensor unit for a motor vehicle for detecting ambient conditions such as, for example, rain or condensation on a window pane, as well as prevailing lighting conditions.

### BACKGROUND

For example, a capacitive rain sensor which, as an option, additionally has a condensation sensor, is known from the German patent application 10 2006 032 372.6. A sensor for sensing ambient light and front area light in a motor vehicle is known from the German patent application 10 2005 055 306.0.

The disadvantage of these individual sensors lies in the fact that they have to be mounted and connected to the on-board electronic system of the motor vehicle individually. An adaptation to a desired sensor configuration of the motor vehicle is very complex.

### SUMMARY OF THE INVENTION

It is therefore the object of the present invention to provide a sensor unit with which the requirements with respect to the sensor configuration of the motor vehicle can be met in a flexible, quick and cost-effective way.

This object is achieved with the features of the patent claim 1. Other advantageous embodiments are specified in the dependent patent claims.

A sensor unit according to the invention for a motor vehicle for detecting ambient conditions comprises at least two sensor modules, wherein a first sensor module has a rain and/or condensation sensor, and a second sensor module has at least a light and/or solar sensor. In this case, there preferably is an electrical and/or electronic connection between the sensor modules.

The rain sensor serves for the detection of liquid such as, for example, rain on the outside of a windowpane of the motor vehicle, in particular the windshield. A formation of condensation which has already occurred or is about to occur is detectable on the sensor side of the windowpane by means of the condensation sensor. The light sensor serves the purpose of determining, for example, the ambient brightness, whereby an automatic control of the driving light is possible, for example. The solar sensor serves the purpose of determining, for example, the intensity of the sun light and/or the position of the sun, in particular for driving an air-conditioning system.

Due to the modular composition of the sensor unit, a high degree of flexibility is achieved with respect to the sensor configuration of a motor vehicle, because only those modules are installed that are fitted with a desired sensor. In this case, each sensor module can be embodied in a modular manner. Thus, the first sensor module is fitted with a rain sensor, a condensation sensor, or a rain and a condensation sensor.

By the electrical and/or electronic connection between the sensor modules, which is, for example, a plug-and-socket connection or a soldered connection, it is accomplished that the sensor modules are able to communicate with one another and that not every sensor module needs to be connected individually to the vehicle electronics system. Therefore, the sensor unit preferably has a joint electronic communication system in one of the sensor modules, in particular an electronic bus system for connecting the sensor unit to a data bus of the motor vehicle. Thus, only one network address is required for the entire sensor unit with respect to the data network of the motor vehicle, independent of the type and number of installed sensors.

In one embodiment of the invention, each sensor module has an electronic evaluation system for evaluating the output signals of the sensors arranged in the respective sensor module. The output signals of the sensors within the respective sensor modules are thus processed and transmitted to the sensor module provided with the electronic communication system, substantially only for the purpose of supplying them to the data network.

In a preferred alternative embodiment, one of the sensor modules has a joint electronic evaluation system for evaluating the output signals of all sensors. In this case, the output signals of the sensors are transmitted substantially directly to the sensor module provided with the electronic evaluation system via the electrical and/or electronic connection. Optionally, a preamplification of the output signals within the sensor module fitted with the sensor is possible, for example. The joint electronic evaluation system and the electronic communication system are preferably accommodated in the same sensor module. The second sensor module preferably is a MID (molded interconnected device) module. The term “MID” refers to technology in which conductor paths can be arranged arbitrarily in an injection-molded article. Due to the design as a MID module, an electrical and/or electronic and a mechanical connection between the sensor modules can be accomplished in a simple manner.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a three-dimensional view of a sensor unit according to the invention;

FIG. 2 is the illustration of FIG. 1 with a housing part being omitted;

FIG. 3 is a cross-sectional representation of the sensor unit taken along the line AA′ from FIG. 1; and

FIG. 4 is a three-dimensional view of the top side of the sensor unit.

### DETAILED DESCRIPTION

The present invention will now be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

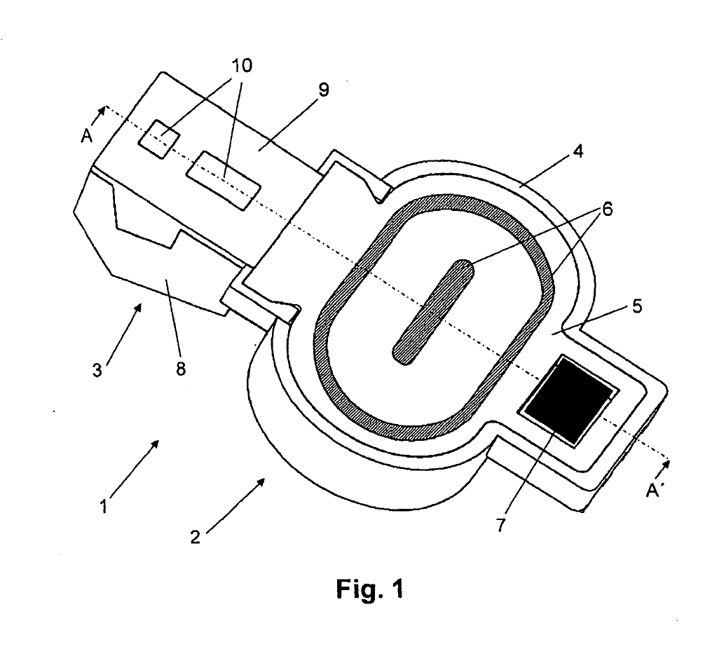

FIG. 1 shows the three-dimensional view of the bottom side of a sensor unit 1 comprising the first sensor module 2 and the second sensor module 3. The first sensor module 2 substantially comprises a housing 4 and a circuit board 5. A capacitive rain sensor 6 in the form of two electrode surfaces is fitted onto the circuit board 5. A condensation sensor 7 is disposed in a recess of the circuit board 5. A more in-depth description of the composition and mode of operation of the first sensor module 2 can be gathered from the German patent application 10 2006 032 372.6.

The basic structure of the second sensor module 3 comprises a housing 8 and a cover 9. A light-transparent element 10 which cooperates functionally with two light sensors (not shown in FIG. 1) is embedded into a recess of the cover 9. Two solar sensors (also not shown in FIG. 1) are disposed in the sensor module 3.

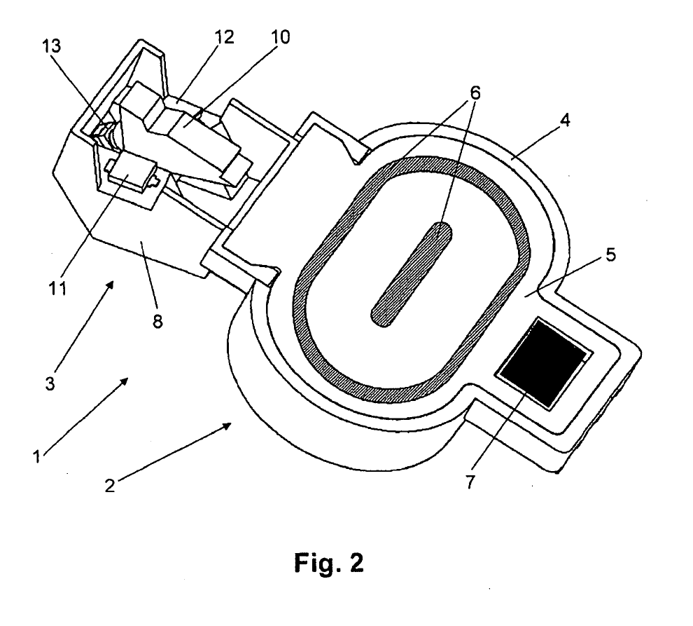

FIG. 2 shows the sensor unit 1 from FIG. 1, with the cover 9 having been omitted for the purpose of illustrating the interior composition of the sensor unit 3. A light sensor 13 which detects the light incident on the light-transparent element 10 from a defined area in space, in particular an area in front of the motor vehicle, is disposed behind the light-transparent element 10. The solar sensors 11 and 12 are arranged in such a way that, apart from the intensity of the incident sunlight, the relative position of the sun relative to the sensor module 3 can also be detected from their output signals. The housing 8 of the sensor module 3 preferably is formed using the MID technique.

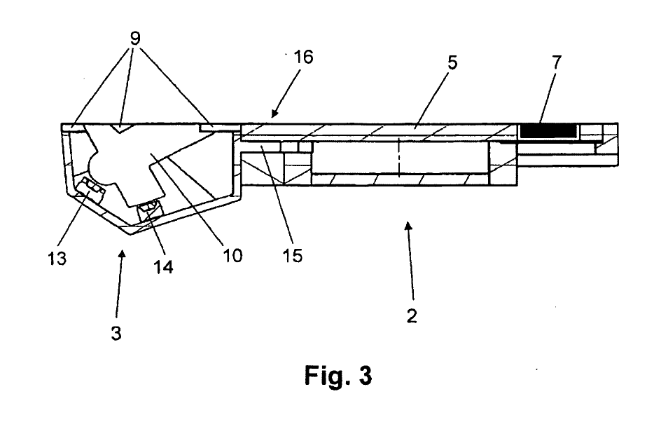

FIG. 3 shows a sectional representation of the sensor unit 1 taken along the sectional edge AA′ from FIG. 1. In this representation, another light sensor 14 is shown besides the light sensor 13 already shown in FIG. 2. As described with respect to the light sensor 13, the light sensor 14 detects the light incident on the light-transparent element 10 from a defined area in space, for example an area above the motor vehicle. The composition of the light-transparent element 10 and the arrangement of the light sensors 13 and 14 can be gathered from the German patent application 10 2005 055 306.0. The light sensors 13 and 14 detect light in the visible frequency range. In order to ensure that only light from defined areas in space hits the light sensors 13 and 14, the cover 9 is preferably nontransparent to light in the visible frequency spectrum, but transparent to infrared light, by means of which the solar sensors 11 and 12 determine the solar intensity and/or the position of the sun.

The electronic evaluation system for evaluating the output signals of all sensors 6, 7, 11, 12, 13, and 14 is preferably arranged on the side of the circuit board 5 facing the interior of the sensor module 2. Alternatively, the electronic system for evaluating the output signals of the sensors 6 and 7 is disposed in the first sensor module 2, and the electronic system for evaluating the output signals of the sensors 11, 12, 13, and 14 is disposed in the second sensor module 3. An electronic bus system by means of which the sensor unit 1 is connected to a data bus of the motor vehicle is also disposed in the first sensor module 2.

The electrical and/or electronic and mechanic connection between the sensor modules 2 and 3 is effected via a projection 15 of the housing 8 which protrudes into an area 16 of the sensor module 2, which area is formed as a socket or opening. Due to the MID configuration of the housing 8, the contacts of the sensors 11, 12, 13, and 14, and of the electronic system disposed in the sensor module 3 are connected with contact surfaces in the area of the projection 15. The area 16 of the sensor module 2 also has contact surfaces that interact with the contact surfaces disposed on the projection 15.

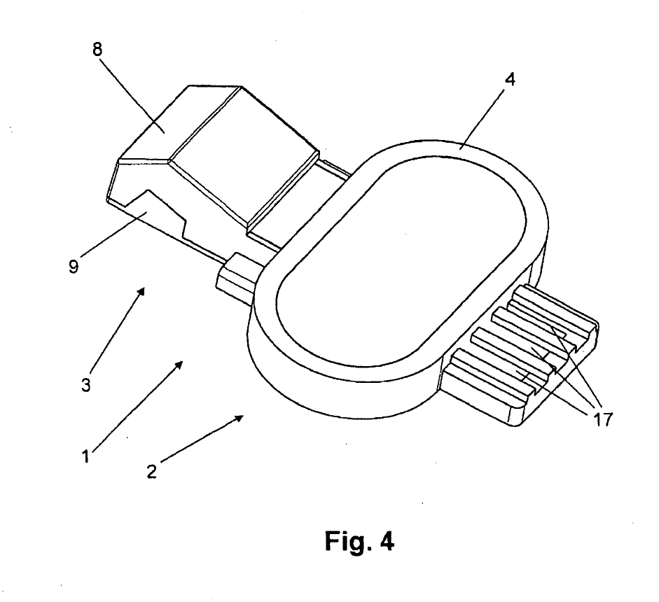

FIG. 4 shows a three-dimensional illustration of the top side of the sensor unit 1. The housing 4 of the first sensor module 2 has recesses 17 through which the condensation sensor 7 (not shown in FIG. 4) is in contact with the interior air of the motor vehicle. The entire sensor unit 1 with all sensors disposed therein can be installed in the motor vehicle in one process step. A mechanical attachment and of electrical and/or electronic contacting of each individual sensor is not required. The sensor unit 1 is attached, for example, with its bottom side on the windshield of a motor vehicle.

Preferably, a sensor unit according to the invention additionally has a connecting device not shown in the figures, for connection to the electronic system of the motor vehicle. This connecting device comprises, for example, a socket for receiving a plug, wherein the socket may be formed as a component of one of the housings 4 or 8, respectively. Alternatively, a cable with a plug leads out of one of the sensor modules 2 or 3, respectively.

The preceding exemplary embodiments are of a purely exemplary nature and thus not limiting. In particular, the kind, the number, and the configuration of the individual sensors may deviate from the embodiments shown without departing from the spirit of the invention. Thus, the light-transparent element 10, for example, is optional. The first sensor module 2 can comprise only one rain sensor or only one condensation sensor. The second sensor module 3 can comprise, only, at least one light sensor or, only, at least one solar sensor. The distribution of the electronic systems, for example the signal preamplifier, the electronic evaluation system or the electronic communication system, on the sensor module can also be varied arbitrarily. The forms of housings shown are also to be understood as being purely of an exemplary nature.

In the drawings and specification, there have been disclosed typical embodiments on the invention and, although specific terms have been employed, they have been used in a generic and descriptive sense only and not for purposes of limitation, the scope of the invention being set forth in the following claims.

1. A sensor unit (1) for a motor vehicle for detecting ambient conditions, the sensor unit comprising at least two sensor modules, wherein a first sensor module (2) has a rain (6) and/or condensation sensor (7), and a second sensor module (3) has at least a light (13, 14) and/or a solar sensor (11, 12).

2. The sensor unit (1) according to claim 1 further comprising an electrical and/or electronic connection between the sensor modules (2, 3).

3. The sensor unit (1) according to claim 1 further comprising a joint electronic communication system, in particular an electronic bus system, for connecting the sensor unit (1) to a data bus of the motor vehicle in one of the sensor modules (2, 3).

4. The sensor unit (1) according to claim 1 wherein each sensor module (2, 3) has an electronic evaluation system for evaluating output signals of the sensors (6, 7, 11, 12, 13, 14) arranged in the respective sensor module (2, 3).

5. The sensor unit (1) according to claim 1 wherein at least one of the sensor modules (2, 3) has a joint electronic evaluation system for evaluating output signals of all sensors (6, 7, 11, 12, 13, 14).

6. The sensor unit (1) according to claim 1 wherein the second sensor module (3) is a molded interconnected device (MID) module.

7. A sensor unit (1) for a motor vehicle for detecting ambient conditions, the sensor unit comprising:
a first housing (4);
a second housing (8) positioned substantially adjacent to the first housing;
a first sensor module (2) supported by at least a portion of the first housing (4), the first sensor module (2) carrying one or more sensors for detecting ambient conditions; and
a second sensor module (3) supported by at least a portion of the second housing (8), the second sensor module (3) carrying one or more sensors for detecting ambient conditions;
wherein the first and second sensor modules (2, 3) are in communication with one another.

8. The sensor unit (1) according to claim 7 wherein the first sensor module (2) carries one or more sensors selected from a rain sensor (6), a condensation sensor (7), or a combination thereof.

9. The sensor unit (1) according to claim 7 wherein the second sensor module (3) carries one or more sensors selected from a light sensor (13, 14), a solar sensor (11, 12), or a combination thereof.

10. The sensor unit (1) according to claim 7 wherein the first and second sensor modules (2, 3) are in electrical communication.

11. The sensor unit (1) according to claim 7 further comprising a joint electronic communication system for connecting the sensor unit (1) to a data bus of the motor vehicle, the joint electronic communication system disposed in at least one of the sensor modules (2, 3).

12. The sensor unit (1) according to claim 7 wherein:
the one or more sensors carried by the first and second sensor modules (2, 3) are selected from a rain sensor (6), a condensation sensor (7), a solar sensor (11, 12), or a light sensor (13, 14), or a combination thereof; and
further comprising:
an electronic evaluation system for evaluating output signals produced by the one or more sensors (6, 7, 11, 12, 13, 14), the electronic evaluation system incorporated into each one of the first and second sensor modules (2, 3).

13. The sensor unit (1) according to claim 7 wherein:
the one or more sensors carried by the first and second sensor modules (2, 3) are selected from a rain sensor (6), a condensation sensor (7), a solar sensor (11, 12), or a light sensor (13, 14), or a combination thereof; and
further comprising:
a joint electronic evaluation system for evaluating output signals produced by each one of the one or more sensors (6, 7, 11, 12, 13, 14), the joint electronic evaluation system incorporated into at least one of the first or second sensor modules (2, 3).

14. The sensor unit (1) according to claim 7 wherein at least one of the housings (4, 8) of the first or second sensor modules (2, 3) is a molded interconnected device (MID) module.

15. The sensor unit (1) according to claim 7 further comprising:
a projection (15) formed at one side of the second sensor module (3); and
an opening (16) defined by one side of the first sensor module (2), the opening for receiving the projection (15) in corresponding engagement;
wherein corresponding engagement between the projection (15) and the opening (16) facilitates communication between the first and second sensor modules (2, 3).

16. The sensor unit (1) according to claim 15 further comprising:
contact surfaces carried by the projection (15);
contact surfaces defining at least a portion of the opening (16);
contacts carried by the sensors; and
leads connecting the contact surfaces of the projection (15) and opening (16) to the contacts of the sensors;
wherein corresponding engagement between the projection and opening provides communication between the first and second sensor modules (2, 3).

17. A sensor unit (1) for a motor vehicle for detecting ambient conditions, the sensor unit comprising:
a first sensor module (2) carrying at least one sensor for detecting ambient conditions;
a second sensor module (3) carrying at least one sensor for detecting ambient conditions, the first and second sensor modules (2, 3) positioned substantially adjacent to one another;
a first housing (4) forming at least a portion of the first sensor module (2), the first housing (4) defining an opening (16); and
a second housing (8) forming at least a portion of the second sensor module (3), the second housing defining a projection (15) for correspondingly engaging the opening (16) of the first housing (4) such that the first and second housings (4, 8) are connected;
wherein the first and second sensor modules (2, 3) are in electrical communication with one another.

18. The sensor unit (1) according to claim 17 wherein:
the at least one sensors of the first and second sensor modules (2, 3) are selected from a rain sensor (6), a condensation sensor (7), a solar sensor (11, 12), or a light sensor (13, 14), or a combination thereof; and
further comprising:
an electronic evaluation system for evaluating output signals produced by the one or more sensors (6, 7, 11, 12, 13, 14), the electronic evaluation system incorporated into each one of the first and second sensor modules (2, 3).

19. The sensor unit (1) according to claim 17 wherein:
the at least one sensors of the first and second sensor modules (2, 3) are selected from a rain sensor (6), a condensation sensor (7), a solar sensor (11, 12), or a light sensor (13, 14), or a combination thereof; and
further comprising:
a joint electronic evaluation system for evaluating output signals produced by each one of the one or more sensors (6, 7, 11, 12, 13, 14), the joint electronic evaluation system incorporated into at least one of the first or second sensor modules (2, 3).

20. The sensor unit (1) according to claim 17 wherein at least one of the housings (4, 8) of the first or second sensor modules (2, 3) is a molded interconnected device (MID) module.
